(19) United States
(12) Patent Application Publication
(10) Pub. No.: US 2019/0193323 A1
(43) Pub. Date: Jun. 27, 2019

(54) A METHOD FOR APPLYING A FILM ON MOULDED FIBROUS PRODUCT AND A PRODUCT PRODUCED BY SAID METHOD

(71) Applicant: Bjorn Nilsson, Kimstad (SE)

(72) Inventor: Bjorn Nilsson, Kimstad (SE)

(73) Assignee: PAKIT INTERNATIONAL TRADING COMPANY INC., Saint Michael (BB)

(21) Appl. No.: 13/704,338

(22) PCT Filed: Jun. 15, 2011
(86) PCT No.: PCT/SE2011/050744

§ 371 Date: Dec. 14, 2012

(30) Foreign Application Priority Data
Jun. 15, 2010 (SE) 1050610-3

(51) Int. Cl. B29C 51/36; B29C 51/12; B29C 33/38

(52) U.S. Cl. CPC B29C 51/365; B29C 51/12; B29C 33/3814; B29K 2101/12; B29K 2995/0067; B29K 2995/006; B29C 33/3842

(57) ABSTRACT

The present invention relates to a permeable suction mould arranged to support a fibrous product during application of a surface film onto a surface of said fibrous product, said mould including suction carrying structure for delivery of suction to the mould surface wherein said suction carrying structure is formed by a porous structure in a sintered material.

### TECHNICAL FIELD

The present invention relates to a permeable suction mould arranged to support a fibrous product during application of a surface film onto a surface of said fibrous product, said mould including suction carrying structure for delivery of suction to the mould surface.

### BACKGROUND ART

A preferred process for making a three-dimensional pulp product, such as a food tray, plate or mug, for example, which is to be provided with a tight surface layer, is disclosed in WO 2006/057610, herewith incorporated by reference. The forming process deposits virgin or recycled fibres onto sintered forming tools via suction in the vat or forming tank. After the forming tank, the fibrous products are pressed and heated between closely matched male and female moulds in a three-stage operation. The results of these three pressing and heating stages are an increase in the fiber density; a smoothing of the surfaces; and tension is built up in the fiber network, which increases the stiffness of the final product.

After the pressing and heating stages, the products are sent for final drying in a microwave dryer. Splitting the drying between the heating and pressing and microwave drying keeps the production rates up and eliminates the common problems of micro-cracking, strength loss and warping found in other fiber moulding techniques. The exceptional rigidity and torsional stability makes it possible for the walls of moulded products to be thinner and to be shaped in a wide range of complicated forms without cracking or deforming during the production and shipping process.

U.S. Pat. No. 4,337,116 discloses a process for bonding a film to such a three-dimensional pulp product. The process includes the steps of rapidly pre-heating a plastic film, and then quickly hot pressing the pre-heated film into contact with the surface of the pre-heated pulp product, and finally cooling the pulp product to room temperature. The die in which holds the pulp product is made with suction ports connected with a vacuum source so that vacuum can be applied through the base during the bonding steps of the process.

EP 1142 690, EP 1 089 912, U.S. Pat. No. 3,957,558 are further patents disclosing laminating while using a die having suction ports connected with a source of vacuum.

A well known problem when laminating film to a product is that it is difficult to achieve an even film layer over three-dimensional structures having sharp edges and/or corners. Further disadvantages related to lamination of film as described in the patents above are that that blisters may form on the pulp product and also that the film may rupture which could result in products having inferior quality and/or high discard frequency.

### DISCLOSURE OF THE INVENTION

The object of the invention is to solve or reduce at least one of the problems mentioned above which according to one aspect of the invention is solved by providing a permeable suction mould comprising suction carrying structure for delivery of suction to the mould surface wherein said suction carrying structure is formed by a porous structure of a sintered material. The object of the invention is also achieved by the use of a permeable suction mould arranged to support a fibrous product, for application of a surface film onto a surface of said fibrous product, said mould including suction carrying structure for delivery of suction to the mould surface and wherein said suction carrying structure is formed by a porous structure in a sintered material.

According to a method of the invention a porous mould is provided for supporting a product during the application of the surface film material, and suction is applied through the pores of the sintered mould. Thanks to the invention there is achieved a mould structure which, when generating a vacuum suction there through, provides an essentially uniform and evenly distributed suction over the entire mould surface including corners and edges. This leads to several advantages when it comes to applying and bonding a film onto a product, in particular a three-dimensional pulp product comprising corners and edges, supported by a suction mould according to the invention.

One such advantage is that the applied film will be drawn onto the product surface with excellent evenness and uniformity. This is achieved thanks to that the porous structure formed by the sintered material will allow for air passage through the mould body in an unpredictable way through the air drainages which are provided around the sintered particles, so that application of a vacuum will create a uniform suction over the entire mould surface, i.e. meaning that a continuous suction is delivered to an equal extent across the whole tool surface at the same time. An even suction across the tool surface will result in even adherence of a film material onto a fibrous product which is supported by such a tool. Another reason to why the suction carrying structure in the form of said sintered mould is so successful when it comes to achieving an even film layer, with minimised risk of blisters, is that it allows for the vacuum to immediately find unattached film portions and heal such portions. If for instance a portion of a film which has been applied onto the product surface would form a blister, i.e. would not succeed to adhere properly to the product, such a blister would lead to a pressure difference at the corresponding location compared to surrounding areas which are properly laminated with the film. The vacuum suction will try to counteract any pressure differences and thanks to the porous structure a vacuum suction passing through the tool may automatically redirect to any site across the applied film layer which is not drawn tightly onto the fibre surface, generating an increased suction force urging the film layer to be drawn tightly onto the product.

The use of a porous tool according to the invention for application of a surface film onto a surface of said fibrous product will enable for the entire film portion intended to be laminated onto the product to become instantly sucked onto the product surface and be brought to tight adherence with the fibers of the pulp product.

Another advantage provided by the use according to the invention is that the risk of accidentally burning the film material during lamination procedure is reduced. The tight adherence of the film material onto the fibers will lead to that the area of contact between the film and the paper product is maximized: the film will be sucked onto the product's surface and follow every structure and/or unevenness present on the paper surface. This will mean that the film becomes almost as an integrated part of the product and the risk of burning reduced since the paper material will protect the film material more efficiently compared to a case where the film is not as tightly adhered on the product surface.

Moreover, since the entire film layer is sucked into tight contact with the product surface essentially simultaneously the film layer properties (e.g. temperature and adhesiveness) can be predicted and thereby optimized more easily compared to conventional lamination processes. The risk that e.g. one portion of the film gets cooled down and loses its adhering properties is hereby minimised.

The sintered suction mould provides an improved way of applying a layer of plastic film onto a fiber product, said film being applicable in an unbroken and continuous manner easily covering any sharp edges and/or corners of three-dimensional structures, and with substantially eliminated risk of blisters. Also, thanks to the uniform suction over the mould surface even a small suction is enough for securing the film onto the product which means the risk of rupture of the film is avoided and thereby the discard frequency lowered.

According to one aspect of the invention the product is placed in a female or on a male porous mould allowing the film to securely adhere to the product by means of applying vacuum through said mould. The film will need some sort of pre-treatment for acquiring adhering properties which may be achieved in a number of different ways known per se. For instance the film may be provided with some sort of glue or the like on the side which is supposed to adhere to the product so that upon contact the film will irreversibly bond to the product surface. Another possibility is pre-heating of the film before it is applied to the product, where such heating process depends on influencing parameters (temp, melting point, etc), however this may in some cases be achieved by merely pre-heating the product, for instance by heating the mould. The mould may be heated e.g. by means of heating elements being integrated within the mould. As an example both the film and the product may be pre-heated, resulting in the film does not risk being cooled down by the product and will therefore attach more easily to the fibres, i.e. the product surface. As is evident for the skilled person many different kinds of heating devices may used to heat either one of the film and/or product, e.g. hot air, radiation, etc.

According to another aspect of the invention the lamination is applied onto the product from a reel of thin plastic film material, which film is pre-treated (e.g. heated) and brought into adhering contact with a first side of the product and adhesively secured thereto by means of drawing a vacuum suction through the porous mould and through the fibre product. Preferably the fibre product is substantially dry when applying the film, preferably it at least 70% dry. The sintered moulds comprise a porous and permeable structure where through air may pass in countless ways which leads to great advantages when drawing the film onto the product surface. Thanks to the vacuum being drawn through said porous structure the entire mould surface is subjected to an even suction affecting an applied film, and thereby the entire film layer is evenly and tightly sucked onto the product surface producing a smooth film barrier without blisters covering any three-dimensional shape and/or irregularities in the fibre structure of the product, and which is preferably impermeable to substances such as water, grease and/or oxygen. Thanks to the uniform suction over the mould surface the entire film layer is sealed onto the product surface at the same time and thereby blistering is substantially avoided. Upcoming of blisters could otherwise pose a problem for instance in case the vacuum suction were to be drawn through the mould for instance via predrilled vacuum openings which would lead to more concentrated suction points at which positions the film risks to be sucked towards the surface more quickly compared to areas distanced from such predrilled vacuum openings thereby risk to rupture. The invention, on the other hand, provides the opportunity of creating an even vacuum suction over the surface of the mould thereby producing an even and tight laminated film layer capable of tightly adhering to various shapes, corners and angles within the product thanks to drawing vacuum through said porous mould of sintered material.

According to another aspect of the invention the lamination is applied onto the product by first forming a web of plastic material brought to superimpose said product and second drawing a vacuum suction through said mould so as to apply the plastic web onto the paper product thereby adhering it to the product surface. According to one example of lamination process vacuum suction is combined with heat treatment for giving the film an adhering property when applied onto the product.

According to another aspect of the invention, a pattern can also be printed on the product or the film material can contain a pigment of a dye. Thereby, a desired appearance of the product can be designed, such as a specific colour or a pattern or figure. This can greatly enhance the product's desirability in specific customer groups.

According to yet another aspect of the invention, the laminated film can form a barrier which is impervious to oxygen. Thereby, a product such as a food product can be protected from the oxygen in air and the aging of the product can thereby be delayed or hindered, which is desirable as it prolongs the life of the product.

According to a further aspect of the invention, a film material which is biodegradable can be used. Thereby, provided that the material used for the product itself is also biodegradable, the product can be degraded in a natural way after use and will result in waste material which is environmental-friendly.

According to another aspect of the invention, the first side of the product, to which the film is applied, is defined as the side that is intended to face upwards when the product is in use. Thereby, the side which is intended to be in contact with a food product, if the product manufactured is a mug, plate, or the like, is especially suitable for containing a substance such as food or drink without said substance being able to penetrate the product and leak out into the surroundings.

### BRIEF DESCRIPTION OF THE DRAWINGS

In the following, the invention will be described in more detail with reference to preferred embodiments and the appended drawings, wherein

FIG. 1 shows a schematic view of a manufacturing process of a moulded fibrous product,

FIG. 2 shows applying of a film onto a moulded fibrous product by means of dispensing a film layer onto a product held by a permeable mould,

FIGS. 3a-c show cross sectional views of three female porous moulds according to three embodiments of the invention,

FIGS. 4a-b show cross sectional zoomings of the embodiments shown in FIG. 3a and

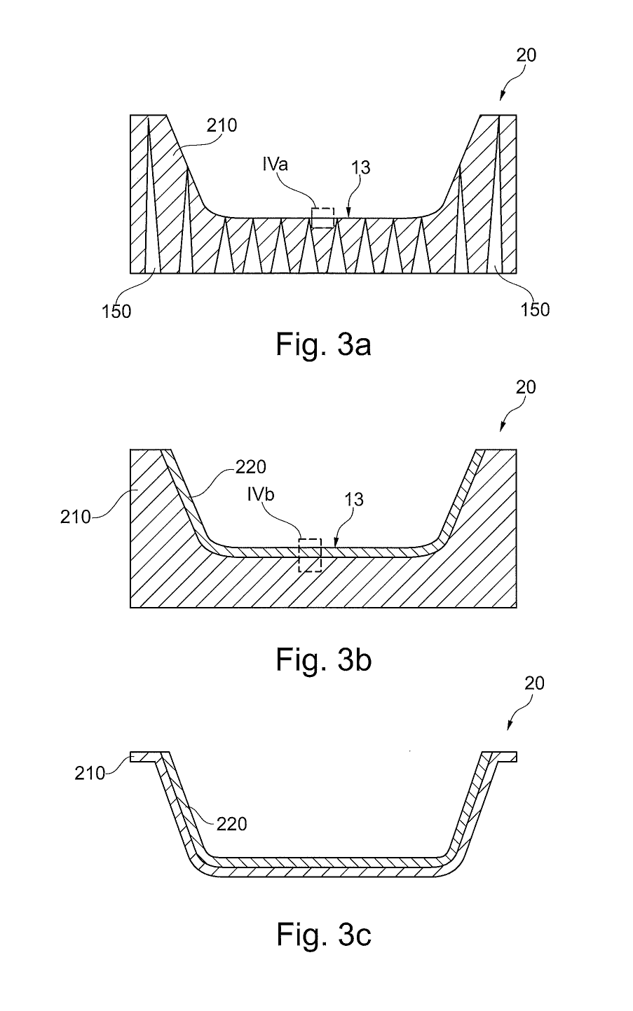

FIG. 3b respectively,

FIG. 5a shows a partly exploded view in perspective of one male pulp mould according to one embodiment of the invention,

FIG. 5b shows an exemplary embodiment of a single base plate according to the invention,

FIG. 6 shows an exploded view of a female pulp mould according to one embodiment of the invention,

FIG. 7 presents a cross sectional view of pulp mould and base plate according to one embodiment of the invention,

FIG. 8 shows an exemplary embodiment of a heating devise according to the invention,

FIG. 9 shows a first embodiment of a cross section of the heating element as shown in FIG. 8, and

FIG. 10 shows a further embodiment of said heating element.

### DETAILED DESCRIPTION OF THE INVENTION

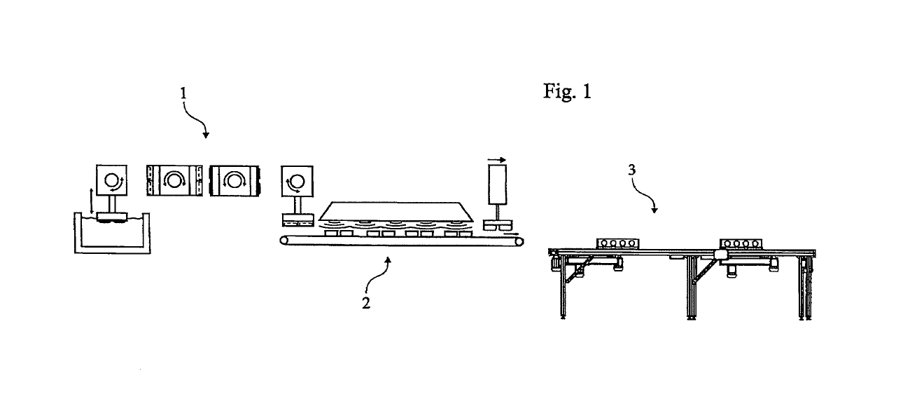

FIG. 1 is a schematic view of a manufacturing process for producing moulded fibrous products showing a forming section 1 for forming a moulded pulp product, a drying section 2 for drying the moulded pulp product, and an after treatment section 3 for subjecting the dried moulded pulp product to after treatment steps such as finishing the edges of the pulp products, packing the pulp products, etc. The film is preferably applied to the product before or during the after treatment section 3 when the product is substantially dried.

When applying the film, the moulded pulp product is supported in a porous mould 10, 20 having a to the pulp product complementary shape. In the forthcoming text male porous moulds are numbered by 10 and female by 20. The porous mould 10, 20 can be of the same kind as used as pulp moulds in the forming section 1, during forming and subsequent pressing. An example of suitable female and male porous mould 10, 20 can be found in WO2006/057609, hereby incorporated by reference. However also other kinds of porous moulds such as e.g. described in U.S. Pat. Nos. 6,582,562, 5,603,808, 5,547,544, WO98/35097 could be used. Preferably the mould have an average pore diameter at the surface in the range of 1-5000 μm, preferably 5-1000 μm, more preferably 10-100 μm, and a pore density of at least 10 cm⁻², preferably at least 100 cm⁻².

Usually it is preferred to apply film on the side of the product which is intended to face upwards, especially if the product created is intended to be in contact with food or drink, such as for instance a plate. Thereby, the impermeability to water and/or grease can be achieved on the side where it has the greatest effect. Usually a female mould 20 would be used to support the product when adding the film. If, on the other hand, it is desired to have the surface barrier film on the opposite side of the product, it would be advantageous to apply the film to the product while it is being held by a male mould 10. In principle suction is applied through the porous mould 10, 20 and through the product supported thereby so that when applying a layer of film onto the surface of the product, the film will be drawn towards and secured onto the surface of the product by means of said sucking force through the mould. Said film may be subjected to heating for achieving an adhering property when applied onto the product. The film material is secured onto the surface and vacuum suction safeguards that the film will cover any possible areas that may not yet be sealed by the film so that a moulded fibrous product having a tight surface film barrier will be produced. Suction can also be used to withhold the product to the mould 10, 20 which can be particularly useful if the mould 10, 20 holding the product is held sideways or facing downwards. The suction pressure is within a negative gauge pressure range from −0.1-−1 bar, preferably −0.6-−0.9 bar.

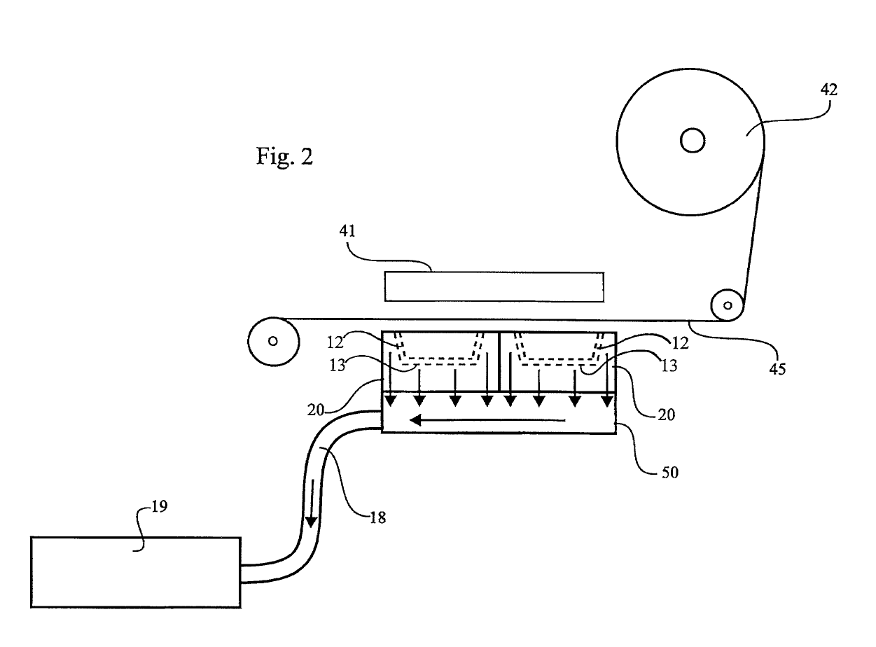

In FIG. 2 there is schematically shown one of many possible ways of applying a film layer 45 onto fibre products 12. A reel 42 of thin plastic film is mounted in such a way superimposing female moulds 20 each having a permeable surface 13 and each supporting a fibre product 12 intended to be laminated with said film material 45. The film is applied to the product by firstly unwinding it from the reel 42 and over the products in the mould 20. The film 45 is thereafter drawn onto the product surface by means of vacuum suction generated by a vacuum suction device 19. The direction of vacuum suction, when applied, is illustrated with arrows in FIG. 2. According to one possible way of laminating the product 12 the film material 45 is pre-heated by heating means 41 for secure bonding onto the fibrous surface of the product 12, or as an alternative the mould 20 itself may comprise heating. The mould 20 may for instance be heated by means of heating means, such as a heating coil (see FIGS. 5-10), being integrated and preferably built in, in connection to sintering the mould 10, 20. Obviously a combination of pre-heating of the film material and heating of the mould is also conceivable. Many different kinds of heating devices 41 may used to heat either one of the film and/or product, e.g. hot air, radiation, etc. As will be later described in more detail (see FIGS. 5-7) the heating moulds 10, 20 are attached onto a tool plate 50 having chambers 51 onto which a female 20 or male 10 mould can be mounted. However, as is understood by a person skilled in the art, heat treatment may be replaced by other methods for adhering the film onto the product surface, for instance by means of glue or other adhesive substance. A suction device 19 is connected to the moulds 20 via a vacuum pipe or hose 18 and creates a subpressure inside the mould 20 providing suction via its permeable surface 13. Preferably only the portion 13 of the surface intended to support a fibre product 12 is permeable, meaning other portions of the surface area is preferably treated to have no permeability/substantially smaller permeability e.g. by applying an impermeable layer (e.g. paint) having appropriate properties.

Due to the suction the film material 45 is tightly sucked onto the material of the product, covering any ruggedness and/or irregularities on the fibre surface, and providing a film barrier that is adhered to and integrated with the surface of the product. Preferably the laminated film is applied after drying the pulp product in dryer section 2 has taken place, i.e. when the product is in the after treatment process marked as 3 in FIG. 1. The materials suitable for use as the film lamination vary, and it may consist of one single material or a laminate comprising several different materials. For instance the film material may be based on petroleum products or renewable substances, e.g. polyethylene terephtalate (PET) or other types of polyester films, polypropylene (PP), polyamide (PA), polyetene (PE), Ethylene Vinyl Alcohol (EvOH), cellulose derivates, starch based films or polylactic acid (PLA).

A starch or sulphite solution has excellent properties regarding the withstanding of grease, while the polymeric materials described are good for withstanding water as well as grease, provided that the surface film created by the method is dense enough.

Preferably, the surface film is impermeable to oxygen as well as to water and grease. Thereby, the oxygen of air can be prevented from reaching through product, which can prolong the life of any food or drink placed on the product since the presence of oxygen generally contributes to the aging process.

The moulded fibrous product is useful not only for food trays and the like, but also for clamshells, plates, and packing material, e.g. for disposable medical products. It can be tailored to a range of specifications, making it an economically superior choice for the protective packaging, foodservice, home meal replacement and healthcare industries, for example. In design, clamshell is a form resembling the shell of a clam, with the ability to open up in the same way.

In FIGS. 3a-3c are seen cross sectional views of three female porous moulds 20 according to three exemplary and schematically shown embodiments of the invention. As has previously been described the mould 20, also referred to as a suction carrying structure, is formed by a porous structure in a sintered material. A method for producing a sintered body is disclosed in WO2006057611, hereby included by way of reference. It is thus understood that the mould, female 20 or male 10, according to the invention comprises a body formed by sintered particles providing a permeable mould with good filtering capability and excellent drainage properties perfectly suitable for allowing passage of air e.g. during application of vacuum suction through said body.

Obviously various shapes of said male 10 or female 20 moulds are conceivable, three whereof are depicted in FIGS. 3a-c. For instance, in FIG. 3a a female mould 20 comprises a core with coarse homogenous pore structure and the particles having substantially the same size. In this particular configuration drainage through the body 20 is increased by having introduced a number of drainage channels 150 each having a pointed end at the portion meeting the surface 13 which is intended to support a fibre product. Although the drainage channels are shown with their pointed end nearby the upper surface 13 of the mould, it is possible to have the pointed end ending substantially anywhere within the body 20.

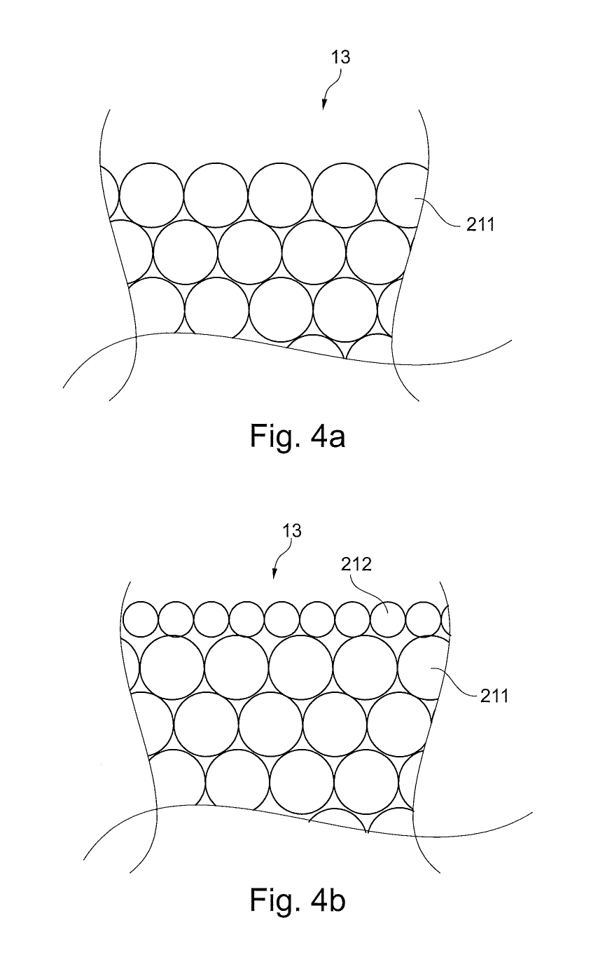

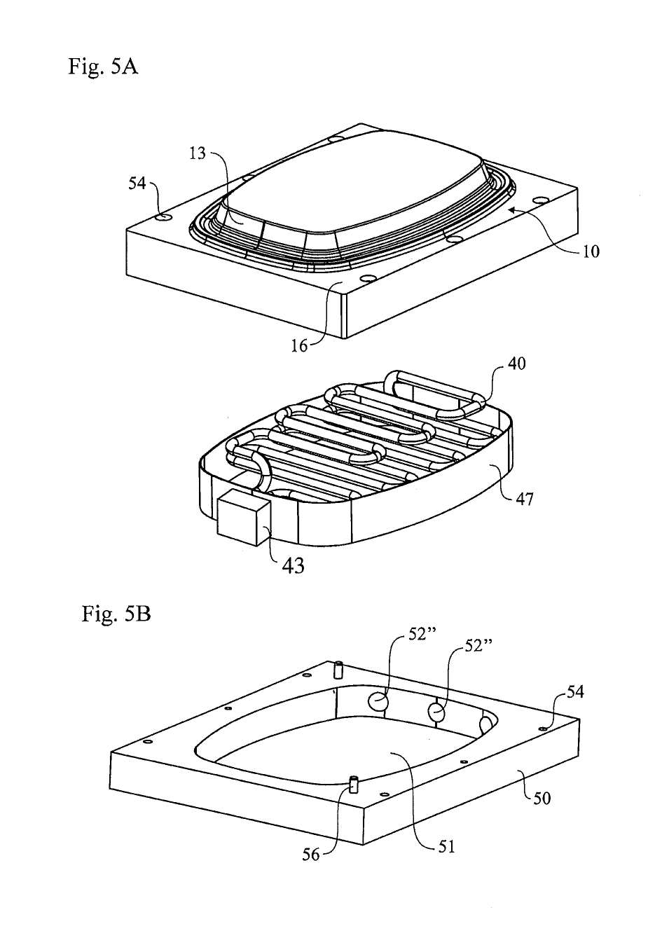

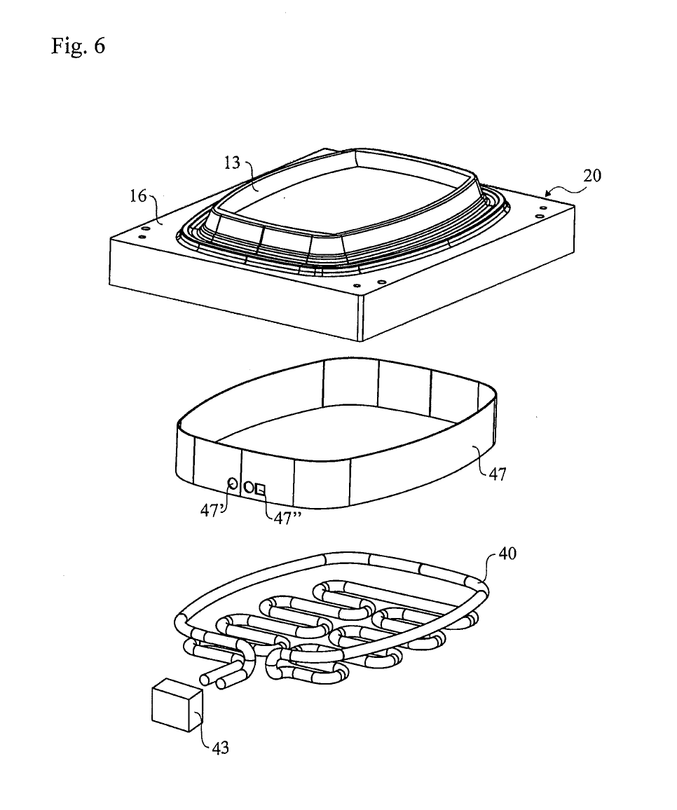

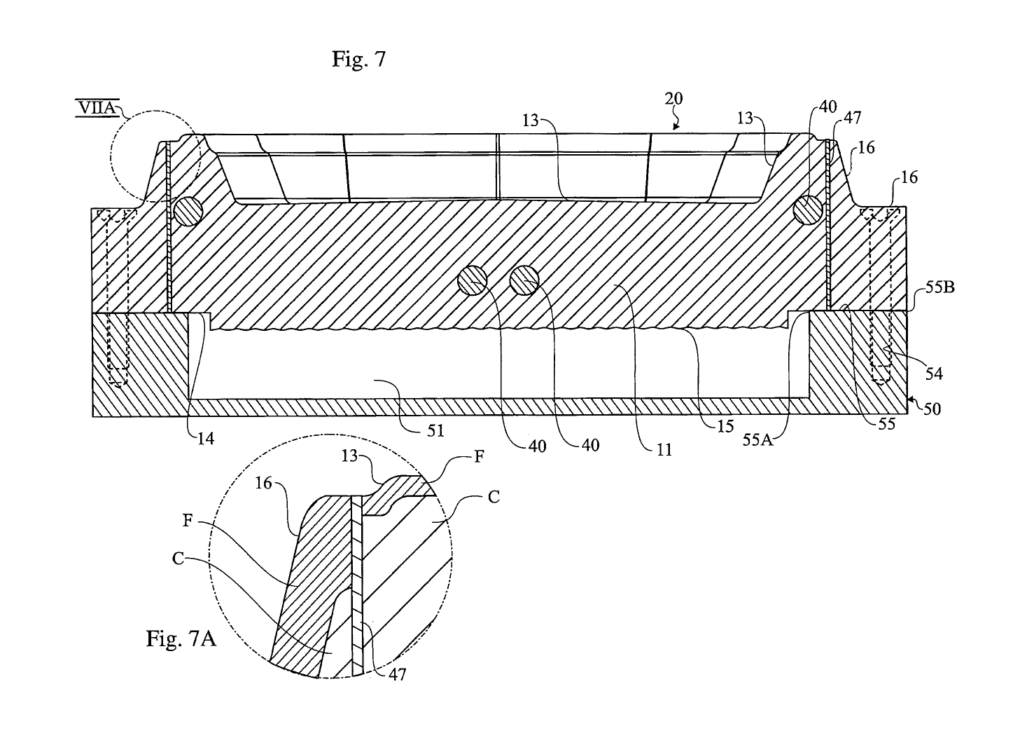

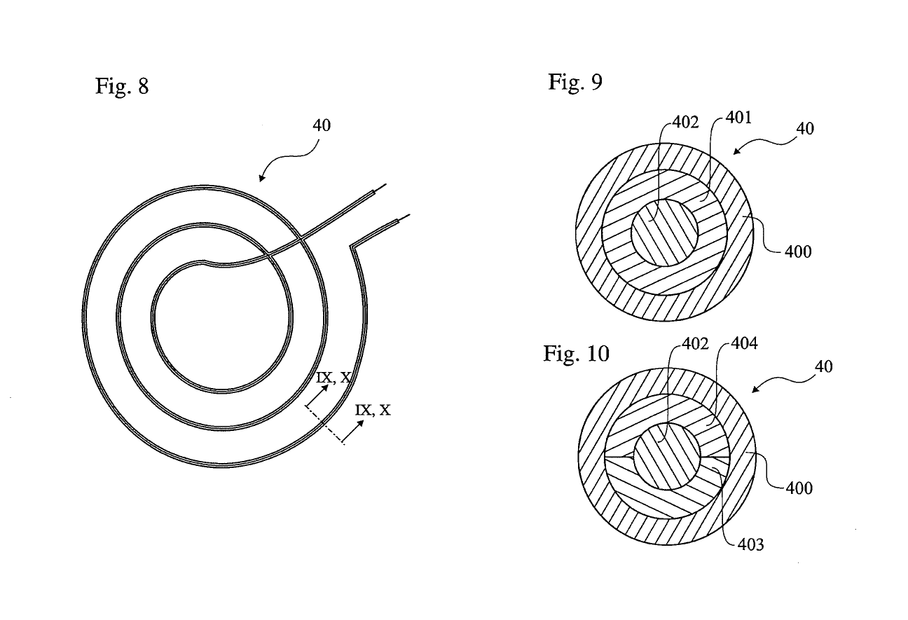

As is understood when studying the cross sectional zooming IVa shown in FIG. 4a the mould 20 comprises particles 211 which have been sintered together to form a porous and permeable structure. As is perceived when looking at the zooming, air will pass through the structure in an unpredictable way, and through the countless air drainages which are provided around the sintered particles 211. This leads to that upon drawing vacuum through the structure the entire mould surface is subjected to an even suction. Thus an applied film layer is evenly sucked towards the product surface, and the risk for blisters or rupture is thereby minimised.

Preferably the mould 10, 20 has an average pore diameter at the surface 13 in the range of 1-5000 μm, preferably 5-1000 μm, more preferably 10-100 μm and a pore density of at least 10 cm⁻², preferably at least 100 cm⁻².

In FIG. 3b is shown another exemplary embodiment according to the invention, here where the mould 20 comprising an inner core 210 with coarse pore structure and an upper layer 220 of fine pore structure, where the fine layer is provided at the upper surface 13 of the mould 20 which is intended to support said fibre product. The structure of the upper layer is further illustrated in the cross sectional zooming IVb, shown in FIG. 4b, wherein the difference in diameter regarding the particles 211, 212 within the layer 220 and the core 210 respectively is further clarified. A thinner uppermost layer 212 could lead to certain advantages when applying suction since it may contribute to an increase of distribution of the vacuum suction at the mould surface which obviously is favorable during lamination procedure.

Yet another embodiment is seen in FIG. 3c, wherein a mere shell 210, 220 formed by sintered particles of suitable sizes constitutes a female mould 20.

Evidently the diameter of the particles to be sintered may be chosen differently for each type of mould depending on the purpose of use and the type of fibre product it is meant to support, and also the properties and structure of different layers of a sintered body may be flexibly varied. It is to be understood that a mould may also be heterogenous and consist of particles having different sizes, or a mould comprising several layers.

In FIGS. 5 and 6 there are shown exploded views of male pulp mould 10 and a female mould 20, respectively, according to one embodiment of the invention. As is evident for a skilled person the same inventive features are of course applicable to both the male and female moulds. The mould 10/20 forms an integral body 11 (see FIG. 7) wherein a heating coil 40 and a sealing barrier 47 are built in, in connection with sintering of the mould 10/20. In the sealing barrier 47 there are formed holes 47′, 47″ of corresponding size and form as the cross-section of the element (heating wire and/or sensor body) intended to pass through. Further there is an interface unit 43 for connecting the heating means 40 and also possibly a sensor. FIG. 5A shows a perspective view of a pulp plate 50 intended to merely carry one mould 10/20. The main purpose of this figure is to present that indeed there is a large variety of the modifications within ambit of the invention, e.g. merely have one mould on top of each base plate 50. Also this figure presents an exemplary solution for providing vacuum to a vacuum chamber 51, which is achieved by drilled holes 52′ leading into the vacuum chamber 51 via appropriate connecting channels 52 (not shown), e.g. branch pipes 52′ leading to a common vacuum pipe 52. Further it is shown that there are positioning pins 56 intended to facilitate mount fitting of the mould 10/20 onto the base plate 50. Moreover it is presented that the base plate 50 may be formed to have a vacuum chamber 51 in the form of through passage and accordingly then use backing plate in connection with the insulating layer at the back of the base plate 50, to provide for reliable sealing and support.

FIG. 7 presents a cross sectional view through a female pulp mould 20 being attached to a tool plate 50, in accordance with the invention. In the following the details of the inventions will be described with reference to a mixture of FIGS. 5-7. The pulp mould 10 includes a porous body 11 with an inner permeable surface 15 and an outer permeable moulding surface 13. The porous body 11 is preferably a loose sintered body from metal powder. In particular copper based powders, preferably bronze powders have been shown to provide very good results. The porous body 11 may be of metal particles of the similar sizes throughout the body 11 or be layered by powder of different size and/or content, to fulfil different needs and mostly having a finer powder at the outer moulding surface.

The pulp mould 10 includes a heating means 40, preferably in the form of resistor heating coils 40 commonly used in electrical stoves. The heating coils have an inner core 402 (see FIG. 9) which is heated by means of electrical resistance. An intermediate layer 401 surrounds the inner core 402. Preferably the intermediate layer 401 is electrically non conductive, but is a good heat conductor for transferring heat to the porous body 11. However, as indicated in FIG. 10 the intermediate layer may comprise an upper portion 404 and lower portion 403, where the upper portion 404 is in a material that is a much better heat conductor than the lower portion 403 which forms an heat insulator, so that heat is directed towards the moulding surface 13. An outer layer 400 preferably of a metallic material surrounds the intermediate layer 401. The outer layer 400 is sintered to the porous body, forming sintering necks to the particles of the porous body 11 which provides for a good heat transfer to the porous body 11. Since the pulp mould 10/20 according to this particular embodiment will be heated during use it is desirable that the heating coefficient of the powder particles and the material of the outer layer 400 are similar. E.g. when using bronze powder in the body it has been shown that copper or a copper based alloy is a good material for the outer layer 400. Copper and bronze can also be sintered at much lower temperature than steel powder in connection with steel heating elements 40; however such a combination may also be possible. The cross-section of the resistor heating coils 40 can be circular as shown in FIGS. 9 and 10, however the cross-section could very well be rectangular or having any other kind of cross-sectional shapes.

FIGS. 5 and 6 present that there is preferably a sealing stripe 47 arranged in the mould 10/20, preferably made of copper to provide a seal between the permeable area (including the outer moulding surface 13) and the area 16 where it is desired not having the mould permeable to vacuum. Accordingly in a preferred embodiment both the heating element 40 and the sealing stripe 47 are positioned into the basic mould (not shown) in connection with the production of the pulp mould 10/20 by means of sintering. When using bronze powder in the body it has been shown that copper or a copper based alloy is a good material for the sealing stripe 47; however other alloys may also be used as the material for sealing stripe 47.

As is evident from the cross section shown in FIG. 7 the heating means 40 and also the sealing stripe 47 will be integrated/embedded into the body 11 of the mould 20. A novel feature presented in FIG. 7 is the use of a limited surrounding machined rear surface 14 of the mould. This rear surface 14 is the only part of the inner moulding surface 12 that is machined after sintering. Accordingly merely a sufficient area is machined to allow for appropriate interfit onto the support surface 55 of the tool plate 50.

Thanks to this arrangement a number of advantages are gained. Firstly it means that merely a minor fraction of the material used in connection with sintering will be wasted, compared to the traditional manner where the whole backside of the mould 20 would be machined to make it flat. Further it will allow for better permeability of the inner surface 15 of the mould, due to the fact that machining will negatively affect that surface by at least partly blocking the pores at the surface 12.

Also the use of sealing stripe 47 will provide considerable advantages. The stripe 47 in an efficient manner seals the outer portion surface 16 of the mould 20 that otherwise will have to be sealed in some other manner that have shown to be either costly and/or not totally reliable. Further it implies that the holes 54 or the screws connecting the mould 20 with the tool plate 50 are also sealed off in an efficient manner, due to positioning the sealing stripe 47 closer to the inner edge 55A of the supporting surface 55 than the outer edge 55B, thereby providing a relatively wide area adjacent the periphery of the mould 20 for the holes 54.

Another evident advantage with the principles of the novel features is that the arrangement of vacuum supply to the vacuum chambers 51 may be achieved in a very compact and cost efficient manner, by integrating the connecting channels 52′, 52″ directly into the tool plate 50. As is evident from FIG. 7 this leads to a very compact arrangement.

As depicted in FIG. 7A, which is a partial cross sectional area including the sealing stripe 47 the part of the mould comprising the surface 16 not intended to be permeable may adjacent the surface thereof be provided with a thicker layer of finer powder particles F to thereby provide extra safety to have it impermeable, i.e. a sufficiently thick layer of fine particles F such that impermeability achieved, whereas on the inside of the stripe 47 that layer F is very thin to achieve a fine and permeable surface 13. As is evident the sealing stripe 47 may assist in efficient building of different kind of layers on the outside and inside respectively thereof 47. Moreover it is evident that the latter kind of functionality may be achieved by using a pre-fabricated frame portion (not shown) which is impermeable and to position that frame portion into the basic mould (not shown), to thereafter use powder to produce the inner permeable body 11 of the mould 20.

The heating means 40 are preferably placed close to the outer moulding surface 13 for good heat transfer to the moulding surface. How close is dependent on the geometry of the pulp mould 10. Preferably though the heating element has at least one active section thereof located at a distance within 20 mm from lowest portion of the moulding surface, preferably within 10 mm, even more preferred within 5 mm.

In FIG. 6 the heating means 40 is shown to be arranged substantially in one level within the central part of the porous body 11, while in FIG. 5 the heating means 40 is arranged substantially in two levels within the central part. It may be possible in simple geometries to let the heating elements follow the contour of moulding surface 13. The heating means in the form of heating coils 40 may of course be wound in different shapes before sintering them into the porous body 11. For instance they may be wound in a circular manner as shown in FIG. 8 or in meander patterns as shown in FIGS. 5 and 6, but of course there are numerous ways of winding the heating elements.

It is to be noted by the person skilled in the art that the methods described above for applying a surface film to a moulded fibrous product being formed can be used with a variety of different manufacturing processes. The invention should be seen as being limited only by the appended claims and not by the specific preferred embodiments described above.

For instance, it has been shown that the product can be held in a position so that the surface of the product to be covered by the film 45 faces upward as well as downward. Obviously it would also be possible to have the mould 20 in a position so that the surface of the product to be covered by the film material 45 faces sideways.

As has also been previously pointed out it is not necessary to heat the mould 10/20. Merely heating the film itself may sometimes be enough, depending on the properties of the film material used for lamination. Of course heating may be omitted if some other adherence procedure is to prefer, such as gluing.

Furthermore, it would of course be possible to apply a film onto the opposite side as well, after a first film has been applied. For the second film layer, it will not be sucked into the product in the same way as for the first layer, since by applying the first layer the product has been made more or less impermeable. Therefore, when applying barriers on opposite sides, it is preferred to apply the first film to the side that is intended to face liquid. It would further be possible to apply multiple films on each side, where preferably each having different properties.

1. Use of a permeable suction mould arranged to support a fibrous product, for application of a surface film onto a surface of said fibrous product, said mould including suction carrying structure (10, 20) for delivery of suction to the mould surface (13) and wherein said suction carrying structure is formed by a porous structure in a sintered material.

2. Use as claimed in claim 1, wherein said suction carrying structure (10, 20) comprises at least one surface layer (120, 130) and a core (110) wherein said at least one surface layer (120, 130) comprises sintered particles of a different size compared to the sintered particles of said core (110).

3. Use as claimed in claim 2, wherein the sintered particles of said at least one surface layer (120, 130) comprises a size which is smaller than the size of the sintered particles of said core (110).

4. Use as claimed in claim 1, wherein said suction carrying structure (10, 20) comprises at least one drainage channel (150).

5. Use as claimed in claim 1, wherein said suction carrying structure (10, 20) comprises a layer (120, 130) of sintered particles.

6. Use as claimed in claim 1, wherein said suction carrying structure (10, 20) comprises a heating device (40) integrally arranged within said structure (10, 20).

7. Use as claimed in claim 6, wherein said heating device is in the form of a heating coil (40).

8. Use as claimed in claim 1, wherein said porous structure comprises a female mould (20).

9. Use as claimed in claim 1, wherein said porous structure comprises a male mould (10).

10. Use as claimed in claim 1, wherein the mould has an average pore diameter at the surface in the range of 1-5000 μm, preferably 5-1000 μm, more preferably 10-100 μm and a pore density of at least 10 cm⁻², preferably at least 100 cm⁻².

11. A method of producing a moulded fibrous product, said method comprising:
a. providing a moulded, hot-pressed fibrous product formed from an aqueous pulp suspension in a vat;
b. applying a surface film to the surface of at least a first side of the product, to produce a moulded fibrous product having a surface film; said method being characterized by
c. providing a suction carrying structure for supporting the product during the application of the surface film; and
d. applying suction through the pores of the suction carrying structure during the application of the surface film material.

12. A method as claimed in claim 11, characterized by applying the film material by applying the film material onto the surface of the first side.

13. A method as claimed in claim 11, characterized by using a film material that forms a barrier, which is impervious to oxygen.

14. A method as claimed in claim 11, characterized by using a film material that forms a barrier, which is biodegradable.

15. A method as claimed in claim 11, characterized by using a film material containing a pigment or a dye.

16. A method as claimed in claim 11, characterized by the first side of the product being defined as the side that is intended to face upwards when the product is in use.

17. A method as claimed in claim 11, characterized by the mould that is used to hold the product when applying the film being a female mould.

18. A method as claimed in claim 11, characterized by the material of the film belonging to the group of polyethylene terephtalate (PET), polypropylene (PP), polyamide (PA), polyetene (PE), Ethylene Vinyl Alcohol (EvOH), cellulose derivates, starch based films or polylactic acid (PLA).

19. A method as claimed in claim 11, characterized by the mould having an average pore diameter at the surface in the range of 1-5000 μm, preferably 5-1000 μm, more preferably 10-100 μm and a pore density of at least 10 cm⁻², preferably at least 100 cm⁻².

20. A moulded fibrous product having a first surface covered with a film material, said product being produced by the method as claimed in claim 11.
